(19) United States
(12) Patent Application Publication
(10) Pub. No.: US 2005/0245660 A1
(43) Pub. Date: Nov. 3, 2005

(54) Tintable chalkboard paint

(76) Inventor: Dayton Joseph Deetz, Mendon, MA (US)

Correspondence Address: Dayton J. Deetz, 43 Taft Avenue, Mendon, MA, 01756, US

(21) Appl. No.: 11/116,603

(22) Filed: Apr. 28, 2005

Related U.S. Application Data
(60) Provisional application No. 60/566,162, filed on Apr. 28, 2004.

(51) Int. Cl. C08K 3/34

(52) U.S. Cl. 524/451

(57) ABSTRACT

The novelty of a tintable chalkboard paint is an important offering for the new do it yourself movement. Chalkboard paints are a different entity than regular paint as they are formulated to be a specific gloss level as well as having certain characteristics to enhance eraseability. The formulation of a Tintable base that gives the consumer the ability to match any color they choose is in need.

### TECHNICAL FIELD OF THE INVENTION

Utilizing a hard acrylic resin with the addition of calcium carbonate and talcum powder in quantities sufficient to render the dry surface of the paint to a very flat, as apposed to glossy finish, will aid its function as a chalkboard surface. This can be achieved in a clear acrylic paint base that will take on any color property desired. By keeping the quantity of talc at a high level the hard acrylic resin will sand like a sanding sealer. This allows the person applying the paint to sand the surface to a very smooth slate- like surface when finished thus creating a true slate type chalkboard that can be blue, red, purple and the like.

### BACKGROUND OF THE INVENTION

Producing a tintable chalkboard base is a new novel product. In the past all chalkboard paints have been manufactured as a paint containing a color, primarily black or green. The invention of a clear chalkboard paint is an innovative way to offer the color choice to the consumer at the place of purchase.

### EXAMPLES

The following examples are presented to further illustrate and explain the present invention and should not be taken as limiting in any regard.

To produce a tintable chalkboard paint this is about a 5-gallon mix

### Example 1

25 lbs of acrylic latex
6.4 oz of Propylene Glycol
10 oz water
16 lbs talcum powder
4 lbs calcium carbonate
6 oz ammonium benzoate
6 oz polyphobe TR 117

Blend latex, Propylene glycol, ammonium benzoate, and water together for 5 minutes. Slowly add dry ingredients. After all talc and calcium are dispensed, mix for additional 10 minutes, add polyphobe TRI 17 and blend for 5 minutes.

1. A tintable paint or coating formulated to except chalk and erase.

2. A clear acrylic paint base suitable to except colorants with about 4 to 10 lbs of talcum powder per said gallon.

3. A tintable acrylic paint base having sufficient amounts of talcum powder to aid in sanding and flatten the gloss of the dry surface suitable for receiving chalk and erasing.
